(19) United States
(12) Patent Application Publication
(10) Pub. No.: US 2022/0343407 A1
(43) Pub. Date: Oct. 27, 2022

(54) Platform Agnostic Remote Checkout Interface

(71) Applicant: Bolt Financial, Inc., San Francisco, CA (US)

(72) Inventors: Yangxue Zhou, San Francisco, CA (US); Gregory Richard Greiner, San Francisco, CA (US)

(21) Appl. No.: 17/240,899

(22) Filed: Apr. 26, 2021

(51) Int. Cl. G06Q 30/06; G06Q 20/40

(52) U.S. Cl. CPC G06Q 30/0643; G06Q 30/0635; G06Q 20/4014

(57) ABSTRACT

In one embodiment, a method includes receiving a request corresponding to a user interaction on a content platform with a content item, the user interaction originating from a user device. The method includes determining, based on the request, an inventory item and a merchant provider of the inventory item. The method includes confirming availability of the inventory item from the merchant provider. The method includes causing a native checkout user interface to be presented on the user device in conjunction with the content platform. The native checkout user interface corresponds to the inventory item determined from the request. The method includes receiving a checkout request for the inventory item via the native checkout user interface presented on the user device. The checkout request originates from the user device. The method includes facilitating an order between the user and the merchant based on the checkout request.

### TECHNICAL FIELD

This disclosure generally relates to interfaces for creating a purchase.

### BACKGROUND

Content publishers or publisher platforms are often used by users to identify goods that the user can later purchase. Content publishers can sometimes receive credit from a merchant when they are able to prove that they sent a customer to the merchant to purchase goods. In order for a user to actually complete the purchase, the user must use their user device to navigate away from the content publisher in order to open the merchant's independent store, find the item, and purchase the item. A content publisher can provide a code identifying the content publisher to the merchant, but the user must remember to use that code. The content publisher may also provide a customized link to the merchant's store that embeds an identifier for the content publisher, but that still requires the user to take steps to leave the publisher's page in order to make and complete a purchase. This added friction can slow users down and reduce the opportunity for them to make a purchase. The user must also enter their payment information into the merchant's checkout page and provide other relevant information. This adds additional layers of friction, and also risks exposure of the user's sensitive information by submitting it to yet another entity online.

Merchant marketplaces can also be used to identify goods for purchase. Merchant marketplaces often include listings for products of many types from many different merchants, competing for the user's attention and purchase inquiry. A merchant marketplace can include tools to facilitate checkout. For example, a marketplace can provide “shopping cart” functionality where a user collects the items they intend to purchase and a checkout functionality through which order details, including payment information and shipping details, can be collected by the marketplace. Upon confirming an order, the marketplace can facilitate processing payment on behalf of the merchants, inform the merchant of the purchase, distribute funds, and distribute shipping details as needed. In this environment, the individual merchants are reliant on the marketplace to handle details such as shipping confirmation and payment processing on their behalf. The merchants are also reliant on the marketplace to provide opportunities to influence a user's purchase decisions.

By requiring users to navigate away from a content platform to complete purchases or require a user to navigate through additional interfaces of a marketplace, present techniques increase the operational burden on user devices, merchant systems, and content platform systems. User devices must execute additional applications or web browser windows. Merchant systems must process requests to assist a user in finding an item they already know they would like to purchase. Content platform systems must introduce additional complications to recall and remove content that the user has already seen or must risk frustrating users with repetitive content and unintuitive interfaces.

### SUMMARY OF PARTICULAR EMBODIMENTS

Embodiments described herein include a method, executed by a transaction processing system for processing an order for a user of a content publisher or content platform through a native checkout user interface that is presented without navigating away from the content platform. In particular embodiments, the method includes the transaction processing system receiving a request corresponding to a user interaction on a content platform with a content item, the user interaction originating from a user device. The transaction processing system determines, based on the request, an inventory item and a merchant provider of the inventory item. The transaction processing system confirms availability of the inventory item from the merchant provider. A native checkout user interface associated with the transaction processing system is presented on the user device in conjunction with the content platform. The native checkout user interface may be invoked by the content platform. The native checkout user interface corresponds to the inventory item determined from the request. The transaction processing system receives a checkout request for the inventory item via the native checkout user interface presented on the user device, the checkout request originating from the user device. The transaction processing system facilitates an order between the user and the merchant based on the checkout request.

In particular embodiments, the design or presentation of the native checkout user interface is determined by the content platform and integrates with the presentation of the content platform. In particular embodiments, the native checkout user interface is presented without the user device navigating away from the content platform. In particular embodiments, the transaction processing system retrieves a presentation template for the native checkout user interface. The presentation template is determined by or based on the merchant provider of the inventory item. In particular embodiments, the transaction processing system receives order transaction information from the native checkout user interface and receives payment information for the user originating from the native checkout user interface. An amount of funds corresponding to the order are later transferred from an account of the user to an account of the merchant using the received payment information. In particular embodiments, the transaction processing system receives identifying information for the user originating from the native checkout user interface and identifies payment information for the user based on the identifying information by retrieving the payment information from a database mapping the identifying information of the user to the payment information. An amount of funds corresponding to the order are later transferred from an account of the user to an account of the merchant using the retrieved payment information. In particular embodiments, the merchant provider operates a merchant inventory system, the merchant inventory system being one of several merchant inventory systems. The transaction processing system identifies the merchant inventory system for the merchant provider from the several merchant inventory systems and the content provided in the native checkout user interface is based on the identification of the merchant inventory system. In particular embodiments, after receiving the checkout request for the inventory item via the native checkout user interface presented on the user device, the transaction processing system sends an order notification to the merchant inventory system. The content of the order notification is based on the identification of the merchant inventory system.

In particular embodiments, prior to receiving the checkout request for the inventory item via the native checkout user interface, the transaction processing system receives a second request corresponding to a second user interaction on the content platform with a second content item, the user interaction originating from a user device. The transaction processing system determines, based on the second request, a second inventory item and a second merchant provider of the second inventory item and updates the native checkout user interface to correspond to the inventory item determined from the request and the second inventory item determined from the second request. Receiving the checkout request for the inventory item via the native checkout user interface includes associating the checkout request with the inventory item and the second inventory item. Responsive to receiving the checkout request, the transaction processing system facilitates a second order between the user and the second merchant. In particular embodiments, the content platform is a non-marketplace content platform. In particular embodiments, the request is received from an advertisement presented by the content platform.

The embodiments disclosed above are only examples, and the scope of this disclosure is not limited to them. Particular embodiments may include all, some, or none of the components, elements, features, functions, operations, or steps of the embodiments disclosed above.

### BRIEF DESCRIPTION OF THE DRAWINGS

FIGS. 1A-1B illustrate an example method for providing a native checkout user interface.

FIG. 2 illustrates a simplified schematic for programming interfaces and endpoints.

FIG. 3A-3D illustrate example user interfaces.

FIG. 4 illustrates transaction processing system platform connections with third party ecommerce platforms.

FIG. 5 illustrates the lifecycle of a purchase order.

FIG. 6 illustrates an example computer system.

### DESCRIPTION OF EXAMPLE EMBODIMENTS

Particular embodiments disclosed herein may be designed to address specific problems or omissions in the current state of the art as described herein. As described herein, particular embodiments include a method, executed by a transaction processing system for processing an order for a user of a content publisher or content platform through a native checkout user interface that is presented without navigating away from the content platform. The user may be understood to be a “shopper” while browsing the content platform that supports the native checkout user interface, because at any time, the user can initiate a request to place an order via the native checkout user interface. In particular embodiments, the method includes the transaction processing system receiving a request corresponding to a user interaction on a content platform with a content item, the user interaction originating from a user device. The transaction processing system determines, based on the request, an inventory item and a merchant provider of the inventory item. The transaction processing system confirms availability of the inventory item from the merchant provider. A native checkout user interface associated with the transaction processing system is presented on the user device in conjunction with the content platform. The native checkout user interface may be invoked by the content platform. The native checkout user interface corresponds to the inventory item determined from the request. The transaction processing system receives a checkout request for the inventory item via the native checkout user interface presented on the user device, the checkout request originating from the user device. The transaction processing system facilitates an order between the shopper and the merchant based on the checkout request.

In particular embodiments, the design or presentation of the native checkout user interface is determined by the content platform and integrates with the presentation of the content platform. In particular embodiments, the native checkout user interface is presented without the user device navigating away from the content platform. In particular embodiments, the transaction processing system retrieves a presentation template for the native checkout user interface. The presentation template is determined by or based on the merchant provider of the inventory item. In particular embodiments, the transaction processing system receives order transaction information from the native checkout user interface and receives payment information for the shopper originating from the native checkout user interface. An amount of funds corresponding to the order are later transferred from an account of the shopper to an account of the merchant using the received payment information. The amount of funds may be transferred by a payment processor selected by the transaction processing system, the merchant, or the shopper. In particular embodiments, the transaction processing system receives identifying information for the shopper originating from the native checkout user interface and identifies payment information for the shopper based on the identifying information by retrieving the payment information from a database mapping the identifying information of the shopper to the payment information. An amount of funds corresponding to the order are later transferred from an account of the shopper to an account of the merchant using the retrieved payment information. The amount of funds may be transferred by a payment processor selected by the transaction processing system, the merchant, or the shopper. In particular embodiments, the merchant provider operates a merchant inventory system, the merchant inventory system being one of several merchant inventory systems. The transaction processing system identifies the merchant inventory system for the merchant provider from the several merchant inventory systems and the content provided in the native checkout user interface is based on the identification of the merchant inventory system. In particular embodiments, after receiving the checkout request for the inventory item via the native checkout user interface presented on the user device, the transaction processing system sends an order notification to the merchant inventory system. The content of the order notification is based on the identification of the merchant inventory system.

In particular embodiments, prior to receiving the checkout request for the inventory item via the native checkout user interface, the transaction processing system receives a second request corresponding to a second user interaction on the content platform with a second content item, the user interaction originating from a user device. The transaction processing system determines, based on the second request, a second inventory item and a second merchant provider of the second inventory item and updates the native checkout user interface to correspond to the inventory item determined from the request and the second inventory item determined from the second request. Receiving the checkout request for the inventory item via the native checkout user interface includes associating the checkout request with the inventory item and the second inventory item. Responsive to receiving the checkout request, the transaction processing system facilitates a second order between the shopper and the second merchant. In particular embodiments, the content platform is a non-marketplace content platform. In particular embodiments, the request is received from an advertisement presented by the content platform.

As described herein, particular embodiments also include a method, executed by a user device of a shopper of the content platform for presenting the content platform and a native checkout user interface to facilitate orders for items corresponding to presented content items. In particular embodiments, the user device displays a user interface including a group of content items provided by the content platform. The user device receives, via the user interface, an input corresponding to a first content item of the content items. The user device sends a request for additional content corresponding to the first content item. The user device displays a native checkout user interface corresponding to a transaction processing system that includes an inventory item corresponding to the first content item determined from the request. The user device receives, via the native checkout user interface, a second user input corresponding to an order request for the inventory item. The user device sends the order request to the transaction processing system. The user device displays the user interface including a second group of content items provided by the content platform. In particular embodiments, the native checkout user interface is displayed as an overlay over the user interface including the group of content items. In particular embodiments, the user device sends the request for additional content corresponding to the first content item to the content platform. In particular embodiments, the user device sends the request for additional content corresponding to the first content item to the transaction processing system. In particular embodiments, receiving the second user input corresponding to the order request for the inventory item includes receiving a confirmation that payment information received from a transaction processing system and displayed within the native checkout user interface is correct. In particular embodiments, receiving the second user input corresponding to the order request for the inventory item includes receiving input of payment information into multiple user input fields and receiving a confirmation that the payment information input into the user input fields is correct. In particular embodiments, the user interface including the group of content items provided by the content platform is a user interface of an application associated with the content platform executing on the user device. In particular embodiments, the user interface including the group of content items provided by the content platform is a user interface of the website associated with the content platform displayed within a web browser executing on the user device.

As described herein, particular embodiments also include a system for performing the methods described herein. In particular embodiments, the system includes a user device, a transaction processing system, and a merchant system. The user device is configured to display content items provided by a content platform in an application executing on the user device, receive a user input corresponding to a first content item of the content items, and send a request to the transaction processing system based on the received user input. In response, the transaction processing system is configured to identify an inventory item based on the request, send a request to the merchant system to confirm the availability of the inventory item, and send instructions to display a native checkout user interface for the inventory item to the user device. In response, the user device is configured to display the native checkout user interface for the inventory item without navigating away from the application executing on the user device, receive an order request for the inventory item via the native checkout user interface, and send the order request to the transaction processing system. The user device may be configured to display the native checkout user interface in response to other input received from the transaction processing system or a third-party system. In response, the transaction processing system is further configured to place an order for the inventory item with the merchant system based on receiving the order request.

Embodiments described herein present technologically-oriented and technologically-enabled solutions to problems that uniquely arise in the field of facilitating ecommerce. As an example, the solutions described herein relate to streamlining the ordering of items by shoppers through intuitive interfaces that directly link content provided by a content publisher or publisher platform with a transaction processing system that manages the relationship between customer and merchant. The solutions described herein particularly relate to a native checkout user interface that presents the shopper with opportunities to quickly purchase an item seen anywhere in a web browser or content-providing application executing on their user device. The web browser or content-providing application can be associated with, for example, a content provider platform, a marketplace, a merchant market platform, or any other suitable platform through which content is presented to a user for consumption. As an example, a user can see an advertisement for a pair of shoes while they are reading a news story and place an order for the shoes through the native checkout user interface without leaving the news story or losing their place on the web page. As another example, a user can interact with an item of user-generated content on a social media website and be presented with a native checkout user interface that allows them to purchase one or more goods depicted in or related to the item of user-generated content. The solutions described herein further relate to specialized configurations of computing systems associated with content platforms or marketplaces, merchants, transaction processing systems, and user devices that enabled the presentation of the native checkout user interface. The configurations of the computing systems are designed to cause the native checkout user interface to appear to the user in a seamless manner, reducing unnecessary use of computing and networking resources by directly facilitating the purchase of the item the user wants.

In particular embodiments, these technical solutions were achieved in part through the development of multiple particularized application programming interfaces (APIs) designed to facilitate all parties to the transactions interfacing efficiently while maintaining high degrees of security and user confidence. These customized APIs can include a “get inventory” API to retrieve inventory information from participating merchants through interfacing with merchant systems and a “get transaction” API to access information about an initiated transaction or a completed transaction, for example after an order has been completed. In addition to the customized APIs, a specially-configured interface accessible on user devices has been developed through which orders for items from merchants can be placed without diverting traffic from a publisher platform or redirecting a user through the publisher platform or a marketplace. Through the coordinated use of these APIs, and other implementation features that may be selected as described herein based on the operation environment of a user device and/or merchant system, potential buyers of goods offered by merchants can encounter a customized and secure checkout experience that feels as though the user has accessed a bespoke merchant website without the buyer needing to actually exit or otherwise be diverted from the content platform. The implementation features can include the use of native software development kit features offered by the providers of the operation environment to further reinforce the feeling of accessing a native, bespoke merchant website. This has the distinct advantage of not requiring the user (e.g., shopper) to be redirected back to the content platform from the merchant's website when the shopper has completed their order and desires to continue browsing the content platform. Because the shopper does not leave the content platform while using the native checkout user interface, the publisher platform can more easily track the user's engagement with the publisher platform and determined, for example, the conversion rates of selected types of advertisement and other content. Content publishers can also more easily attribute the activity on their platform to merchant purchases while greatly reducing reliance on shoppers to provide the attribution for them.

The native checkout experience is provided by a transaction processing system that manages the relationship between content publishers, merchants, and shoppers (e.g., potential customers of the merchants). The native checkout experience is enabled through the integration of certain components, described herein, into merchant systems and publisher platforms. Through the native checkout experience, a shopper can easily place orders for items correlated with content items presented to the shopper without leaving the security of the content platform itself.

The native checkout experience further enables high levels of customization of the checkout experience for shoppers, in particular the look and feel of the native checkout user interface with which the shopper interacts to complete transactions. In particular embodiments, the native checkout user interface, and overall experience, can be customized to varying degrees by each of the parties involved: the content platform (e.g., to maintain a consistent design, even when a shopper is checking out), merchants selling goods through the content platform (e.g., to maintain a consistent branding and standout from the content platform), the transaction processing system, or the shopper (e.g., according to preferences associated with the shopper's profile). In particular embodiments, a content platform can customize the user interface and user experience of the native checkout in order ensure the shopper is comfortable making the online purchase using the transaction processing system. The high levels of customization can also create the effect of the shopper moving between different merchant storefronts without needing to actually be redirected away from the core content platform. In particular embodiments, the merchant can further configure options to be presented during checkout. For example, a merchant can specify a description or availability of discounts relating to the customer, particular inventory items, or shopping through the content platform. As another example, a merchant can specify shipping rates that may be available to a customer based, for example, on the types or quantities of items purchased. The native checkout user interface can be configured to account for the merchant's preferred customizations and be updated accordingly during various stages of the checkout process.

The transaction processing system may offer a platform through which merchants can install programming modules, referred to as plug-ins, to quickly enable new features of the transaction processing system platform including the native checkout user interface. Additionally or alternatively, the transaction processing system may offer a set of customized APIs to allow the merchant access to the same features with options for more nuanced levels of control. These customized APIs can include, by way of example only and by limitation a programming interface to allow the transaction processing system to check if inventory of a specific item offered by the merchant is available (e.g., a get-inventory API). The programming interface can vary in levels of sophistication, where the merchant can optionally select how much information they wish to make available to the transaction processing system and the availability of technical resources to support the programming interface and ensure it is working as intended. As an example, a basic level for the get-inventory API can be a simple inventory check for a given product identifier, such as a universally-unique identifier or stock keeping unit (SKU). When the transaction processing system sends a request to the merchant system with a SKU, the merchant system can reply with a number of available items in inventory. A more complex level for the get-inventory API can provide information on variants to the item, such as colors and sizes. Calls from the transaction processing system can include requests for specific variants. Responses from the merchant system can include the number and type of variants in addition to the number of available units. Another more complex level for the get-inventory API can include the merchant system providing information for when unavailable variants are expected to become available.

Another customized API can include a programming interface to allow the transaction processing system to reserve inventory items for a shopper and create a checkout request with the merchant (e.g., a create-checkout API). The create-checkout API can also vary in levels of complexity. For example, a create-checkout API can merely reserve the number of items for a given shopper until the shopper cancels an order. As another example, the create-checkout API can return errors if the requested inventory item is unavailable, if the requested number of inventory items is unavailable, or if the requested inventory items is invalid (e.g., the inventory system of the merchant does not contain a provided SKU).

As described herein, the merchant can choose how to integrate the native checkout features into their merchant systems. As an example, a merchant can use an inventory management system that is maintained by a third-party. The third-party can determine to support the native checkout experience so that the merchant merely needs to enable the feature. The transaction processing system can then identify the third-party or the type of inventory management system being used and tailor requests to that merchant accordingly. As another example, a merchant can use a custom inventory management system that is configured to implement plug-ins or other standalone blocks of software provided by the transaction processing system. The merchant can integrate such plug-ins into their inventory management system. As yet another example, a merchant can configure their merchant systems to respond to APIs provided by the transaction processing system. For example, the transaction processing system can provide a guide to the various APIs including expected behavior and returned information and trust the merchant to implement the APIs accordingly.

In order for the content publisher to enable access to the native checkout experience, the content publisher must also configure computing system appropriately. For example, depending on the operating platform for which the content publisher is enabling access, they may be asked to register an application name or uniform resource locator with the transaction processing system or the operation system. As explained herein, doing so may enable the transaction processing system to provide callback information directly to the publisher application or website. The publisher may also specially-configure how content items are presented and displayed. For example, as described herein, the publisher can determine that the native checkout experience should be enabled for certain types of content. For these types or items of content, the publisher must configure user input relating to those content items to make calls to the transaction processing system and/or merchant rather than merely serving content in the standard fashion. Additionally, the publisher platform can enable merchants to register certain types of content (e.g., advertisements) as being linked to the native checkout experience for their storefront. This reduces the manual work required to enable each individual merchant who desires to use the native checkout experience. The publisher platform also configures endpoints to listen for messages from the transaction processing system indicating successful checkout. If a shopper has a native checkout interface enabled when a successful checkout message is received, the native checkout user interface can be safely closed, and the publisher platform can return the shopper to the standard content platform experience.

In particular embodiments, transaction processing system can create a workflow for the publisher platform to follow to fully enable the native checkout experience. As described above, this sign-up workflow can include the content publisher registering their application and/or website (e.g., the content platform) so that the transaction processing system can appropriately handle requests to and from the content platform. Registering the application can also provide access to certain of the programming interfaces implemented or enabled by the merchants as described above. The publisher can also create a unique token with the transaction processing system. The unique token may be used, for example, to associate the content platform with requests to and from merchants. The publisher can receive and store merchant keys (generated by or for merchants wishing to sell through the native checkout experience). The publisher can also generate their own keys for the merchants. These keys can then be registered by the transaction processing system to the merchant's keys. The merchant keys can provide access by the publisher platform 120 to the merchant's programming interfaces, including access to inventory information.

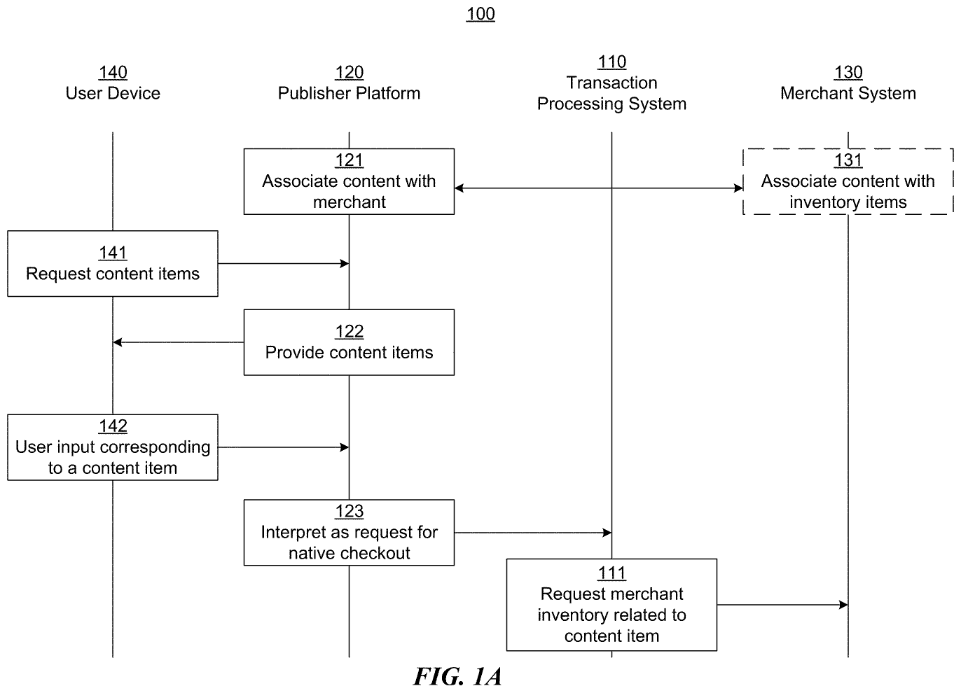

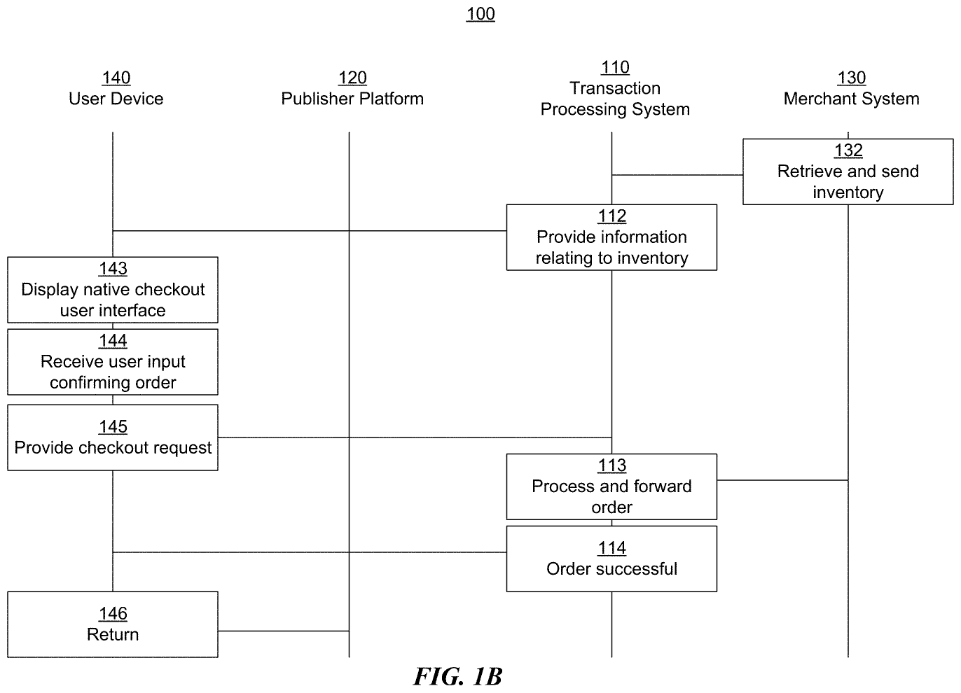

FIGS. 1A-1B illustrate steps of an example method 100 that may be performed providing and using the native checkout user interface. As described herein, before any of the illustrated steps are performed, the merchant integrates a native checkout plugin into their merchant systems 130 or otherwise provides a method for the transaction processing system 110 to query the merchant's inventory systems and place orders with the merchant on behalf of customers. Similarly, before the steps are performed, the publisher integrates features of the native checkout experience with the publisher platform 120 so that requests for content can be interpreted as requests to activate the native checkout experience.

At 121, the publisher platform 120 registers content items as being associated with a particular merchant and/or with particular inventory items offered by the merchant. As indicated, at 131, the merchant system 130 can coordinate with the publisher platform 120 to designate particular pieces of content. In particular embodiments the content can be designated in variety of manners. For example, the merchant can select pieces of paid content, such as advertisements to be used as associated with the native checkout experience. Additionally, the merchant can request that features of the publisher platform 120 are associated with the merchant and/or inventor items.

At 141, a user device communicates with the publisher platform to request content items from the publisher platform 120. In particular embodiments, a user device can include a computing device with varying degrees of portability, such as a desktop, laptop, smartphone, tablet, etc. As an example, the user device 140 can be executing an application native to the operating system of the user device 140 that is affiliated or otherwise associated with the publisher platform 120. As another example, the user device 140 can be executing a web browser that is accessing a website maintained by the publisher platform. The publisher platform 120 can be configured to handle requests from many different types of user devices 140 concurrently.

At 122, the publisher platform 120 provide content items to the user device 140 responsive to the request from the user device 140. The provided content items can be any content items which a user device 140 can interact with based on user input. Suitable content items can include, but are not limited to, images, video, advertisements, links, games, text, audio, etc.

At 142, the user device 140 receives a user input from a user corresponding to a selected content item. The user device 140 can receive the user input via a user interface corresponding to the publisher platform, such as a user interface of a native application or web browser. The user input can include a deliberate selection by the user of the user device 140. Such a deliberate selection can take many forms and can be interpreted by the user device 140 as a request from the user for more information relating to the content item. The user device 140 can send a request for more information to the publisher platform 120. In particular embodiments, the user device 140 can be configured to identify the content item as corresponding to a native checkout request and can further contact the transaction processing system 110 without requiring an intermediate connection to the publisher platform 120.

At 123, the publisher platform 120 receives the request from the user device and interprets the request. In some cases, the request may be a standard request for more information, such as to provide more content related to the content item. The request can also be a request to display more of the content item, or the content item at a higher resolution. At 123, the publisher platform interprets the request as a request for the native checkout experience. The publisher platform 120 may determine that the content item is one that was associated at step 121 with a merchant and the native checkout experience per the merchant's request. Additionally, the request may include metadata or parameters that specifically requests the native checkout experience. To facilitate the native checkout experience, the publisher platform 120 issues a request to the transaction processing system 110.

The transaction processing system 110 interprets the request and prepares the native checkout user interface for display to the user on the user device 140. For example, in certain embodiments, as illustrated by the method 100 shown in FIGS. 1A and 1B, the transaction processing system first confirms that inventory is available by, at 111 issuing a request to the merchant system 130. At 132, the merchant system 130 determines the availability of the item in the inventory and provides the inventory count to the transaction processing system 110. At 112, the transaction processing system provides the information relating to the inventory to the user device 140 for display to the user. This can include a positive indication that the item is available, a count of the items available, an indication that the item is no longer available, or some other more complex accounting of the inventory.

At 143, the user device 140 displays the native checkout user interface to the user. In certain embodiments, the inventory count may not be shown to the user. Instead, the input received at 142 at the user device 140 can be interpreted as a checkout request. As described herein, the native checkout user interface may be displayed to the user as an overlay or modal that appears on top of or above the content normally displayed in the user interface of the content platform. In certain embodiments, the native checkout user interface is displayed as a mobile application window, mobile application view, browser window, WebView, etc. The mobile window application view, browser window, etc., can optionally be loaded as directed by the transaction processing system 110 with information corresponding to the proposed transaction, such as identifying information for the merchant, the user (if known), the item corresponding to the content item selected by the user, preferred payment information of the user (if known), preferred shipping information of the user (if know), and others. In particular embodiments, the native checkout user interface can be displayed with a variety of user input fields through which the user can provide necessary information, including payment details and shipping information.

In particular embodiments, the transaction processing system 110 supports storing accounts for users with the transaction processing system, independent of the merchant and/or publisher platform. Thus, the user can use a single account to store and reload information across multiple merchants. The transaction processing system can store user identifying information, such as an email or phone number, in association with payment information, shipping information such as preferred addresses and shipping types, and other related information. In addition, the transaction processing system can store a device identifier for the user device, so that the user can be identified by the device without needing to enter identifying information. If this information is stored, the transaction processing system 110 can identify the user before causing the native checkout user interface to be displayed on the user device at 143 and fill in the applicable information for the proposed order.

At 144, the user device 140 receives user input confirming the order for the item presented in the native checkout user interface. Where the user's payment and shipping information has been supplied by the transaction processing system, the user input may include a simple acceptance of the order, such as by user engagement with a button marked “Pay Now.” Where the user's payment and shipping information is not available or appears to require supplementation, the user input can input entry of missing information into appropriate user input fields. At 145, the user device 140 sends a checkout request to the transaction processing system 110. The checkout request will be based on the information entered by the user at 144.

At 113, the transaction processing system 110 receives the checkout request and confirms the information on file for the user or entered by the user into the user device at 144. The transaction processing system can also validate the terms of the order. For example, depending on the type of items being sold, there may be restrictions on where or how the items can be shipped. A merchant can instruct that delivery is enabled only for certain geographic regions. These geographic regions can be defined by government regulation. Furthermore, the transaction processing system can validate that selected shipping options are feasible, such as by confirming whether an expected weight or content of the item can be shipped according to the selected shipping method. The transaction processing system then places the requested order by contacting the merchant system 130 to provide the merchant system with information about the order, such as shipping information for the user, payment information, and the item and quantity requested by the user. The transaction processing system 110 can also providing the payment processing information to preferred payment processing partner of the merchant system 130. In certain embodiments, the transaction processing system ensures that an amount of funds corresponding to the transaction moves from an account of the user (e.g., the shopper) to an account of the merchant system in accordance with the confirmed transaction. As an example, the transaction processing system can request that the amount of funds are transferred with or by a payment processor. The payment processor can be selected by the transaction processing system, by the merchant, or by the shopper. The payment processor can be selected based on the type of account used by the shopper and/or the merchant, the type of currency used, and/or other payment made available by the merchant or selected by the shopper during the checkout process.

At 114, if the order is successfully placed, the transaction processing system 110 informs the user device 140 that the order has been successfully placed. The user device 140 can display a confirmation to the user before closing the native checkout user interface 140 and returning, at 146, to the expected content display. In particular embodiments, the user device 140, in closing the native checkout user interface (e.g., closing the corresponding application view, browser window, WebView, etc.), the user device 140 sends a message to the publisher platform 120 to inform the publisher platform 120 that the order was placed successfully.

In particular embodiments, the native checkout user interface can be configured to handle more than one type of item at a checkout and can further be configured to accept purchases from more than one merchant at a time. As an example, after the native checkout user interface is displayed, at 143, the user can select an option to continue browsing or keep shopping. The method 100 then generally repeats. The user can interact with another content item and view an updated native checkout user interface that includes items from both content interactions. In this way, the native checkout user interface can mimic a shopping cart experience on any publisher platform 120 that has been configured to support the native checkout user interface. This has the benefit of adding additional features to technical systems that simply did not exist in the absence of the native checkout user interface. When the user device 140 does provide a checkout request to the transaction processing system. The transaction processing system can break the orders up as needed (e.g., based on the merchants involved) and handle them as individual checkout requests. This further reduces the computational requirements of the user device and moves the responsibility for managing the several orders to the transaction processing system 110, which is best suited to identify the various merchants, payment processing requirements, and other details. This also saves the user time and energy in coordinating the several orders at once.

In particular embodiments, certain errors can occur over the course of the method 100. The native checkout user experience can be designed to gracefully handle the errors to ensure that the user is made aware of the nature of the errors if appropriate and to resolve the errors when possible. For example, one error that may occur includes one or more of the computing systems shown in FIGS. 1A and 1B not being available. As an example, the merchant system 130 may be inactive or otherwise unreachable. In this case, the transaction processing system 110 can cause the user device 140 to inform the user of the unavailability and request the user to try again. As another example, one or more of the unique keys for the publisher platform 120 obtained during registration or the merchant key, which may be provided by the publisher platform 120 to the transaction processing system 110 (e.g., during step 123), may be incorrect. The transaction processing system may detect this error based on a database of the transaction processing system not containing the provided key as a registered key. The transaction processing system 110 can information the party that supplied the key of the error. As another example, errors can arise with respect to the items to which the provided content items are associated. For example, a content item can include a reference to, or association with, a discontinued item. The content item can be associated with an item identifier that does not exist in the merchant inventory. The transaction processing system can inform the publisher platform 120 or user device 140 of the error. The transaction processing system 110 can also optionally escalate the error with the merchant or an administrator if the error occurs repeatedly in order to investigate whether a systemic error has occurred.

Particular embodiments may repeat one or more steps of the example process(es), where appropriate. Although this disclosure describes and illustrates particular steps of the example process(es) as occurring in a particular order, this disclosure contemplates any suitable steps of the example process(es) occurring in any suitable order. Moreover, although this disclosure describes and illustrates an example process, this disclosure contemplates any suitable process including any suitable steps, which may include all, some, or none of the steps of the example process(es), where appropriate. Furthermore, although this disclosure describes and illustrates particular components, devices, or systems carrying out particular steps of the example process(es), this disclosure contemplates any suitable combination of any suitable components, devices, or systems carrying out any suitable steps of the example process(es).

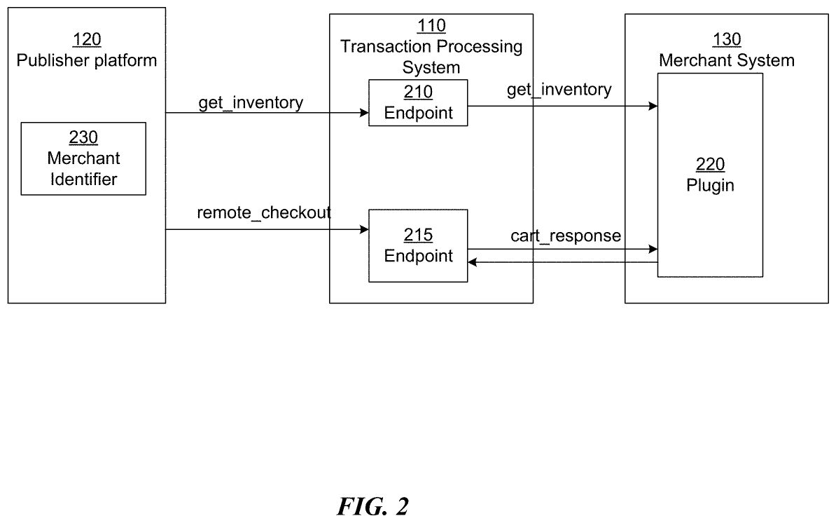

FIG. 2 illustrates a simplified schematic view of the publisher platform 120, transaction processing system 110, and merchant system 130. As described herein, the publisher platform 120 has received a merchant identifier 230, through which the publisher platform can identify a particular merchant to the transaction processing system. The merchant identifier 230 can also serve as a verification that the publisher platform 120 has an existing relationship with the merchant system 130 such that the publisher platform 120 should be permitted to access the programming interfaces provided by the merchant system.

The transaction processing system 110 has, as illustrated, a number of endpoints 210 and 215 which are used to handle different types of requests from the publisher platform 120 and merchant system 130. As an example, when the publisher platform issues a call on a get inventory programming interface to the transaction processing system 110, the call is received on the endpoint 210. Upon verification of the merchant identifier 230, the transaction processing system sends a get inventory call to the merchant system 130. The merchant system 130 may have programming interfaces that have been implemented to handle calls from the transaction processing system. As illustrated in FIG. 2, the merchant system 130 has implemented a plugin 220 associated with the transaction processing system 110 to simplify the process of handling calls. The plugin 220 provides the advantage of including built-in functionality for certain types of inventory systems that will ensure compatibility with the native checkout experience. For example, the transaction processing system 110 can record or identify the type of inventory system used by a particular merchant (e.g., by using the merchant identifier to map the merchant to a type of inventory system) and adjust calls to the merchant system 130 accordingly. The other endpoint 215 of the transaction processing system 110 is configured to send and receive ongoing updates to the user's cart in response to requests from the merchant. The illustration in FIG. 2 shows only a few of the programming interfaces and endpoints that may be used by the various systems of the native checkout experience.

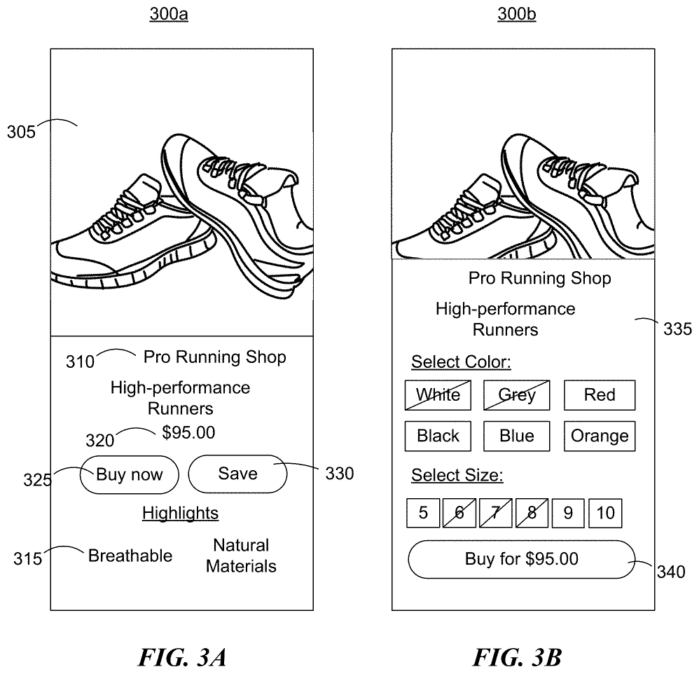

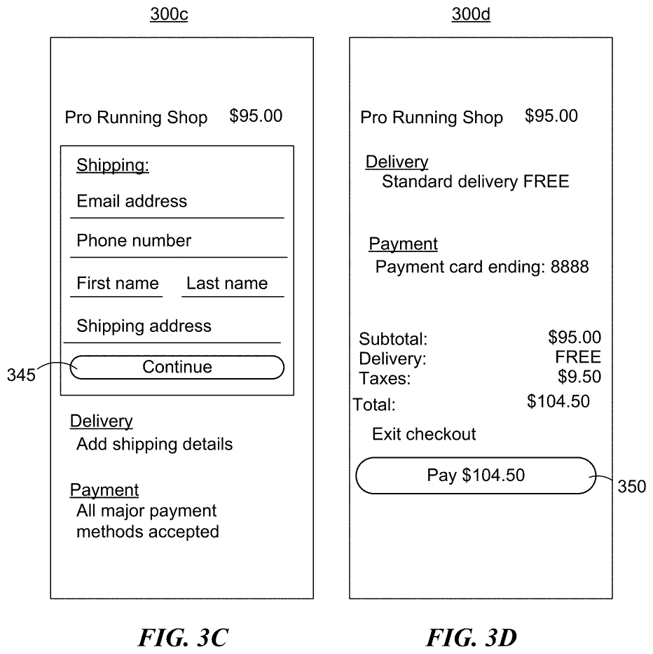

FIGS. 3A-3D illustrate an example of the native checkout user interface executing on a user device while also displaying content items of a content platform.

FIG. 3A illustrates a first example user interface 300a. The user interface 300a includes a content item 305 provider by a content publisher platform. The content item 305 relates to an item for sale by a merchant. In the example illustrated in FIG. 3A, the content item clearly identifies the merchant 310, product details 315, and price 320. The user interface includes an interactive element 325 through which a user can purchase the inventory item corresponding to the content item 305. The interactive element 325 can further include indications through color or iconography indicating that the native checkout user interface will be activated upon interaction. The user interface 300a further includes an interactive element 330 through which the user can save the item to be reviewed later. The interactive element 330 can be a feature supported natively by the content publisher platform.

FIG. 3B illustrates a second example user interface 300b. The user interface 300b shows the native checkout user interface 335 which is provided for display to the user after the user has selected the interactive element 325. In the example illustrated in FIG. 3B, the merchant is able to provide detailed inventory information, such as alternative color options for the inventory item, alternative sizes for the inventory item, and indications for the availability of the selected color and size combination. The native checkout user interface 335 includes an interactive element 340, indicating to the user that they can proceed with the transaction through interacting with the element 340.

The user interface 335 is provided, in one example as a WebView in response to the user's device generating a GET request to the transaction processing system with a specially formatted URL. Although a WebView is described, it will be understood that any suitable mobile browser shell, development kit or API can be used. In particular embodiments, the native checkout user interface is particularly configured using native programming interfaces made available by the operating system used by the user device and/or by the content platform. As an example, the URL to launch the WebView can be in the format https://connect.tps.com/remote_checkout?key=KEY&token=ORDERTOKEN&signature=SIGNATURE. Where the key, token, and signature are all parameter names to be accepted by the transaction processing system and the KEY, ORDERTOKEN, and SIGNATURE all correspond to variables that will be passed with the GET request. In particular embodiments, the signature parameter is required by the operating system of the user device to validate the transaction. As an example, the token parameter corresponds to an order token generated by the content platform with the transaction processing system upon receiving a selection of a content item. Other possible parameters and their use are summarized in the table below.

| Parameter | Description |
|---|---|
| email | Email to be populated on checkout user interface |
| (optional) | Parameters should be encoded |
| phone | Phone to be populated on checkout user interface |
| (optional) | Can be in local or international (E.164 formatting) format. |
| | If phone is in local format (2025550101) |
| | checkout user interface shows |
| | phone number country depending on user API. |
| | If phone is in E.164 format (+12025550101) |
| | phone number country can |
| | be shown depending on phone number. |
| | Parameter should be encoded, e.g. |
| | as phone = %2B12025550101 |
| firstName | First name of buyer. |
| (optional) | |
| lastName | Last name of buyer. |
| (optional) | |
| addressLine1 | Address line 1 for shipping. |
| (optional) | |
| addressLine2 | Address line 2 for shipping |
| (optional) | |
| city | City for shipping |
| (optional) | |
| state | State for shipping. Accepts both abbreviation |
| (optional) | and long form (e.g. CA, California) |
| zip | Zip for shipping. Accepts short and long |
| (optional) | (5 and 9 digit) for US. |
| country | Full country name for shipping. |
| (optional) | |

FIG. 3C illustrates a third example user interface 300c. The user interface 300c is shown in the native checkout user interface when the user has selected interactive element 340. The user interface 300c includes a variety of input fields through which the user can enter identifying information, such as email or phone number. The user can also enter payment information, shipping information, and other information necessary to complete the transaction. Upon entering all necessary information, the user can select interactive element 345. To cause the user interface to transaction to user interface 300d illustrated in FIG. 3D. User interface 300d corresponds to a final confirmation page. The user can verify the presented information and selected interactive element 350 to place the order and cause the user device to send the order to the transaction processing system for processing. In particular embodiments, the user identifying information can be provided to the transaction processing system before the user needs to enter it in user interface 300c. In these embodiments, the transaction processing system can use the identifying information to determine if payment and shipping information of the user is available. If so, the native checkout user interface to skip to the confirmation interface 300d.

Once the order is confirmed successful by the transaction processing system, the transaction processing system can instruct the user device to close the application view or window corresponding to the native checkout user interface. In certain embodiments, closing the interface can be performed through various methods depending on the operating system or computing platform of the user device, for example, whether the publisher platform is being accessed by the shopper through a native application or browser. As an example, in a first application platform, the transaction processing system may redirect the buyer's device to a specified link indicating that payment has been completed. The redirect may be present as, for example, a deeplink of the form <appname>://PaymentResult?status=success&data=<PAYLOAD>. The PAYLOAD may include the signature included in the URL of the GET request and an order reference number. The application may be configured to handle such a deeplink as an indicator of a successful payment. Other redirects may be used to convey the status of the purchase checkout. For example, if the user exist the checkout window before completing the order, the transaction processing system may send a different deeplink indicating through the status that the payment was unsuccessful (e.g., <appname>://PaymentResult?status=failure). As another example, the transaction processing system may send a deeplink indicating a reason why the transaction was unsuccessful through the status or the payload (e.g., <appname>://PaymentResult?status=window_closed).

In other platforms, rather than use a deeplink to convey the payment status to the content platform application, the transaction processing system application view may emit a message. The content platform application may listen for specific messages and close the window. The message can include an indication of success or failure and payload with further information if needed. In particular embodiments, errors associated with the checkout (e.g., an incorrect payment card number entered; payment card declined) may be conveyed within the checkout interface. The message emitted by the transaction processing system can further indicate that the checkout interface was closed by the user before payment completes.

As discussed herein, the presentation of the native checkout user interface can be adjusted according to the needs and goals of the publisher platform. For example, the publisher platform may ensure that all checkout experiences appear generally similar to assure the user that they are still on the publisher platform and haven't encountered an untrustworthy website. As another example, the publish platform may permit merchants to customize the presentation to fit the merchant's branding goals. This gives the merchant checkout pages a unique identity and creates look and feel of entering the merchant's typical checkout page, even though the user has not left the publisher platform. Additionally, the transaction processing system can inject its own brand into select portions of the native checkout user interface, such as buttons that will cause a charge to be placed. This can be used to assure the user that the payment will be processed securely. Additionally, the user can require certain customizations of the native checkout user interface by decluttering the checkout window or adjusting font size, color, and clarity parameters to assist with usability. These customizations can co-exist and be executed according to a priority set by the publisher platform or transaction processing system.

Particular embodiments disclosed herein may provide one or more of the results, effects, or benefits described herein. Particular embodiments disclosed herein may be implemented using one or more example architectures described herein. Underlying foundational concepts and terms of art relied upon may relate to one or more of the following:

The Bolt Platform is an example of a transaction processing system platform as the term is used herein. The Bolt Platform consists of four conceptual parts. The frontend that serves both the main consumer checkout flow as well as internal and external dashboards and administrative tools. The core services that power the checkout flow as well as fraud detection and payments. Bolt is architected as a set of independent services which communicate to each other via HyperText Transfer Protocol Representational State Transfer (“HTTP REST”) or AMAZON Web Services Simple Queue Service (“AWS SQS”) messages. The Bolt Application Programming Interface (“Bolt API”), which is the primary means by which merchant systems interface with Bolt, exposed to the outside world via HTTPS REST. Plugins, which are deployed to merchant systems and which connect these systems with the Bolt API.

Other foundational concepts and terms of art may relate to one or more of the following:
Processor integrations to automate chargeback handling (syncing, representment)
A regression model to predict chance of winning a representment. From the regression model the system may derive the expected value.
A classification model to recommend action items to the merchant. Example action items including fighting chargebacks or not or what is the most valuable evidence.
Merchant integration to potentially generate evidence automatically. Evidence may include:
   AVS results
   CVV results
   Billing/shipping addresses
   Historical orders
   Shipment receipt
   Tracking details
   Third party data on the user

In all example embodiments described herein, appropriate options, features, and system components may be provided to enable collection, storing, transmission, information security measures (e.g., encryption, authentication/authorization mechanisms), anonymization, pseudonymization, isolation, and aggregation of information in compliance with applicable laws, regulations, and rules. In all example embodiments described herein, appropriate options, features, and system components may be provided to enable protection of privacy for a specific individual, including by way of example and not limitation, generating a report regarding what personal information is being or has been collected and how it is being or will be used, enabling deletion or erasure of any personal information collected, and/or enabling control over the purpose for which any personal information collected is used.

The core services and the APIs of the Bolt Platform can include:
“API”—which is the set of APIs that power the checkout flow
“adminapi”—which is the set of APIs that power the admin dashboard.
“apihooks”—which sends webhook messages to merchant's shopping platforms
“AsyncJobs”—which is the job framework to handle long-running asynchronous operations
“Notifier”—which sends notifications such as emails and short message service (“SMS”) messages
“Imageproxy”—which is a lightweight proxy to serve images

Backend services may be written in go (with some machine-learning (“ML”) logic in python used for risk modeling). Frontend components may be written in React/Typescript. Data may be stored in Postgres, hosted by a relational database service (RDS). Another database used for state management may be Redis.

“Tokenizer” is a completely separate service, available in a serverless way to handle card tokenization. Tokenizer may be maintained completely separate do payment card industry security standards. Tokenizer may be made available in a serverless way, for example, through a service such as AMAZON Lambda. The tokenizer may be implemented in Typescript, powered by a postgres DB. All of the tokenizer infrastructure may be maintained by a separate provider account, with access restricted to a few people.

Below are more details about key services and technology components.

| Service/Component | Purpose/Functionality | Frameworks/Languages |
|---|---|---|
| API | All communication with 3p services, | Golang |
| | front end code, business logic | |
| Connect.js and | Connect.js used for rendering checkout | React |
| iFrame | button, entry point for merchants | Typescript |
| | IFrame is how we host checkout form, | Webpack |
| | secure communication with API | |
| checkout frontend | Components used to collect user | React |
| | information during checkout | Redux |
| | | Webpack |
| | | Typescript |
| Notifier | Microservice for enqueueing and | Golang |
| | sending email and SMS notifications to | SQS |
| | consumers and merchants. | MAILGUN |
| | | TWILIO |
| Account.js and | Used for BigCommerce account | React |
| iFrame | dashboard - also uses an Iframe to | Redux |
| | display data | Webpack |
| | | Typescript |
| Shopping Dashboard | Features added to above Account.js | React |
| | | Redux |
| | | Webpack |
| | | Typescript |
| Asynchronous jobs | Heavy lifting of job logic to perform | Golang |
| | tasks like funding, risk review, etc | Redis |
| | | Machinery |
| Apihooks (i.e | Microservice for enqueueing and | Golang |
| Webhooks) | sending webhook events to merchant | SQS |
| | platforms. | |
| Payment jobs | Scheduler for Asyncjobs framework | Golang |
| | | Machinery |
| | | Redis |
| Search | service to index transactions for | Golang |
| | merchant dashboard | Elastic Search |
| Tokenizer | PCI compliant serverless lambda to store | Node.js |
| | credit card information. Used to proxy | AWS Lambda |
| | information to 3rd parties | AWS Key Management |
| | | Service (“KWS”) |
| | | AWS RDS |
| Gatekeeper/A/B | Experimentation and feature rollout | Typescript |
| experimentation | platform | AWS Simple Storage |
| | | Service (“S3”) |
| | | AWS CLOUDFRONT |
| Sleet | Provides a standardized wrapper for | Golang |
| | implementing many payment processor | |
| | gateways. | |
| Risk pipeline | Modeling training and model serving | Golang |
| | | Python |
| | | SAGEMAKER |
| Track.js and iFrame | Used to track customer behavior when | Typescript |
| | they land on merchant's page. Used for | React |
| | risk signals | |
| Ledger | Double write bookkeeping service for | Golang |
| | funds. Tracks money movements | |
| | through the system | |
| Chargeback | Automated system to pull chargeback | Golang |
| management | information from various payment | React |
| | processors and display to merchants in | Typescript |
| | the merchant dashboard chargeback portal | |
| Reporting and | Reports pulled from Vantiv and | Golang |
| Reconciliation | asyncjob with the ledger to ensure fee | Asyncjobs |
| | collection | AWS S3 |
| Merchant Dashboard | Centralized dashboard for all actions and | GraphQL |
| | reporting related to a merchant's | React |
| | management of their Bolt system. | Typescript |
| Admin Dashboard | Centralized dashboard for all internal | GraphQL |
| | actions related to managing Bolt | React |
| | merchants. | JavaScript |
| Admin API | API for actions done by Bolt internal | Goland |
| | employees (onboarding merchants, | GraphQL |
| | turning on features) and majority of use | |
| | is for risk review | |

Integration with ecommerce platforms is supported in two ways. First, directly via the API. Second, with plugins deployed to the host instance.

Database: Data is stored in highly available postgres databases backed by AWS RDS. Databases can scale their components within available limits for disk (up to 16 TB), CPU/ram/network (db.x1e.32xlarge which is 64 cpu and 3,904 TB RAM).

Messaging: Both Consumer and Merchant-facing components do messaging through our Notifier Service.

Data Access: Services communicate via REST. GraphQL is used pervasively for all non-external endpoints.

Data Warehouse: A cloud data warehousing service may service as the main data warehouse that stores the refined data. AMAZON ELASTIC MAPREDUCE may be used for extract, transform, load (“ETL”) workflows and general analysis of the raw data. AWS Step functions, triggered by a cloud watch event, and AWS Lambda may be used to run the ETL workflows. Results may be loaded into the data warehouse. Code such as ETL scripts may be separately managed. Data consumers (e.g. analysts who look at checkout events) use may use plugins to run queries.

Hosting model: The systems may run on highly available containerized backend services backed, for example, by DOCKER and KUBERNETES on AWS. The backend services may be scaled up/down with zero downtime. Infrastructure for serving the frontend code is highly available and backed by AWS. Frontend serving automatically scales with traffic load.

Logging: Frontend (Bolt checkout modal) logs are sent to an error monitoring and reporting tool. All backend applications (e.g., api, paymentjobs, asyncjobs, notifier, etc.) and infrastructure logs (e.g., kubernetes, AWS) are sent to a cloud monitoring platform. Logs may be archived for long-term storage.

Monitoring: High and low level monitors exist to notify engineers of issues. Monitors are replicated to non-production environments to ensure issues can be caught before they make it to production. Monitors are managed in code to ensure consistency and to track changes. Overall application service-level agreements (SLAs) are measured, and lower level monitoring of metrics and logs may be performed using a cloud monitoring platform.

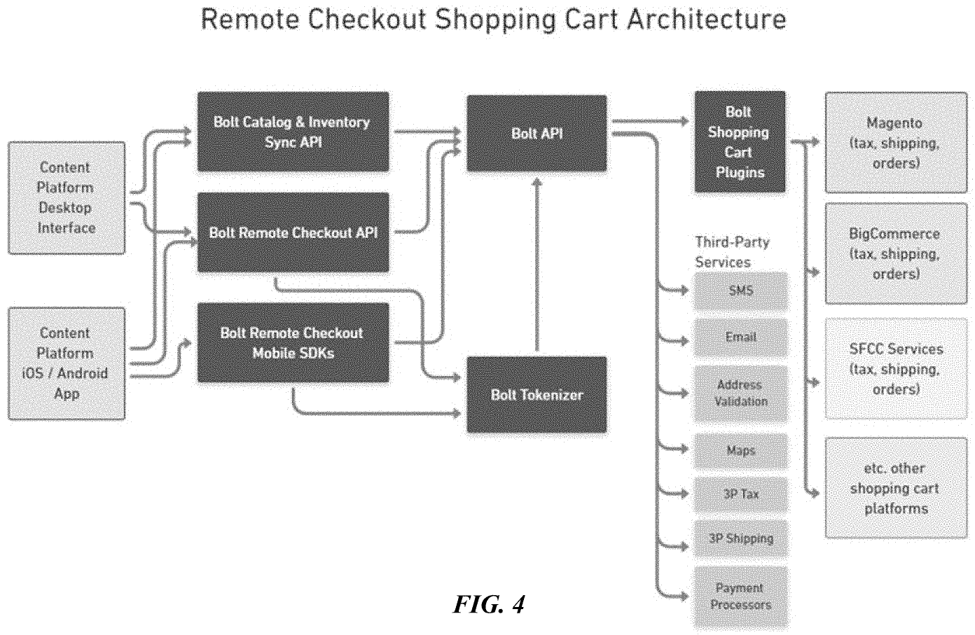

FIG. 4 is helpful in understanding how the platform connects with a third party ecommerce platform.

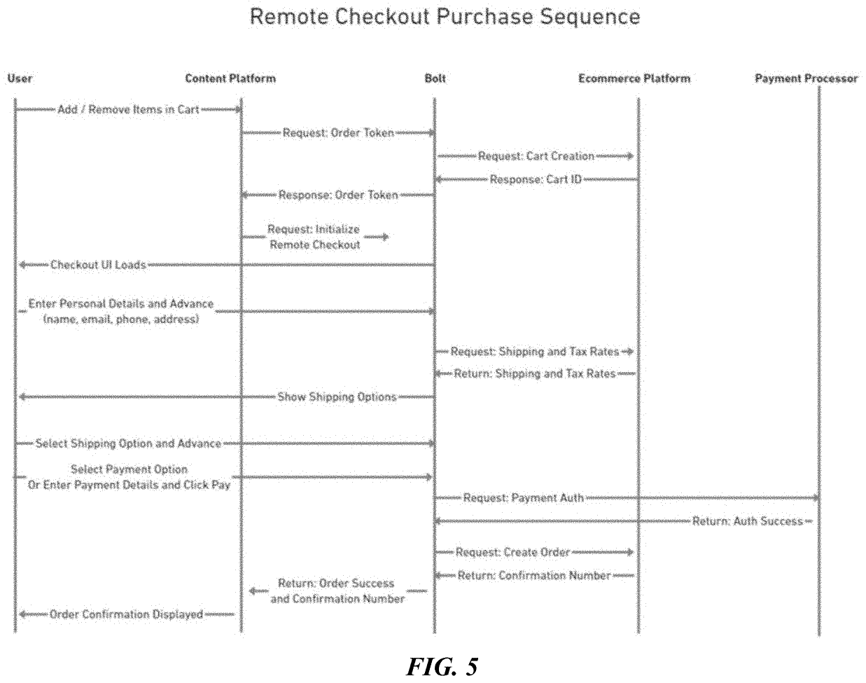

FIG. 5 illustrates the lifecycle of a purchase order.

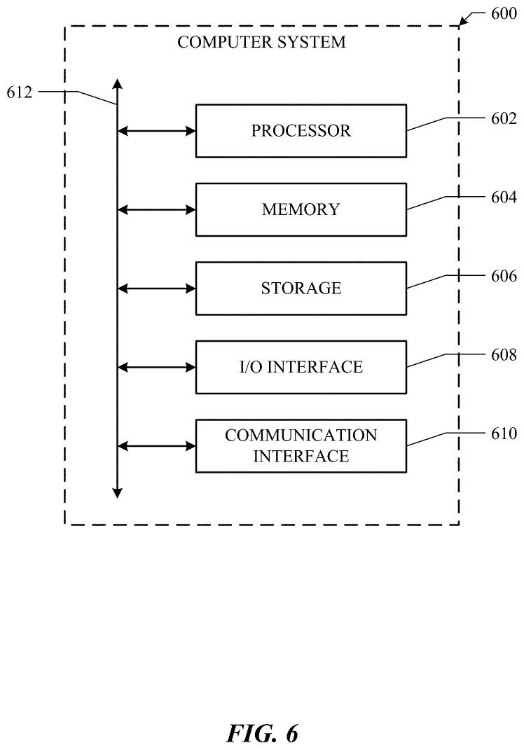

FIG. 6 illustrates an example computer system 600. In particular embodiments, one or more computer systems 600 perform one or more steps of one or more methods described or illustrated herein. In particular embodiments, one or more computer systems 600 provide functionality described or illustrated herein. In particular embodiments, software running on one or more computer systems 600 performs one or more steps of one or more methods described or illustrated herein or provides functionality described or illustrated herein. Particular embodiments include one or more portions of one or more computer systems 600. Herein, reference to a computer system may encompass a computing device, and vice versa, where appropriate. Moreover, reference to a computer system may encompass one or more computer systems, where appropriate.

This disclosure contemplates any suitable number of computer systems 600. This disclosure contemplates computer system 600 taking any suitable physical form. As example and not by way of limitation, computer system 600 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, a tablet computer system, or a combination of two or more of these. Where appropriate, computer system 600 may include one or more computer systems 600; be unitary or distributed; span multiple locations; span multiple machines; span multiple data centers; or reside in a cloud, which may include one or more cloud components in one or more networks. Where appropriate, one or more computer systems 600 may perform without substantial spatial or temporal limitation one or more steps of one or more methods described or illustrated herein. As an example, and not by way of limitation, one or more computer systems 600 may perform in real time or in batch mode one or more steps of one or more methods described or illustrated herein. One or more computer systems 600 may perform at different times or at different locations one or more steps of one or more methods described or illustrated herein, where appropriate.

In particular embodiments, computer system 600 includes a processor 602, memory 604, storage 606, an input/output (I/O) interface 608, a communication interface 610, and a bus 612. Although this disclosure describes and illustrates a particular computer system having a particular number of particular components in a particular arrangement, this disclosure contemplates any suitable computer system having any suitable number of any suitable components in any suitable arrangement.

In particular embodiments, processor 602 includes hardware for executing instructions, such as those making up a computer program. As an example and not by way of limitation, to execute instructions, processor 602 may retrieve (or fetch) the instructions from an internal register, an internal cache, memory 604, or storage 606; decode and execute them; and then write one or more results to an internal register, an internal cache, memory 604, or storage 606. In particular embodiments, processor 602 may include one or more internal caches for data, instructions, or addresses. This disclosure contemplates processor 602 including any suitable number of any suitable internal caches, where appropriate. As an example, and not by way of limitation, processor 602 may include one or more instruction caches, one or more data caches, and one or more translation lookaside buffers (TLBs). Instructions in the instruction caches may be copies of instructions in memory 604 or storage 606, and the instruction caches may speed up retrieval of those instructions by processor 602. Data in the data caches may be copies of data in memory 604 or storage 606 for instructions executing at processor 602 to operate on; the results of previous instructions executed at processor 602 for access by subsequent instructions executing at processor 602 or for writing to memory 604 or storage 606; or other suitable data. The data caches may speed up read or write operations by processor 602. The TLBs may speed up virtual-address translation for processor 602. In particular embodiments, processor 602 may include one or more internal registers for data, instructions, or addresses. This disclosure contemplates processor 602 including any suitable number of any suitable internal registers, where appropriate. Where appropriate, processor 602 may include one or more arithmetic logic units (ALUs); be a multi-core processor; or include one or more processors 602. Although this disclosure describes and illustrates a particular processor, this disclosure contemplates any suitable processor.

In particular embodiments, memory 604 includes main memory for storing instructions for processor 602 to execute or data for processor 602 to operate on. As an example, and not by way of limitation, computer system 600 may load instructions from storage 606 or another source (such as, for example, another computer system 600) to memory 604. Processor 602 may then load the instructions from memory 604 to an internal register or internal cache. To execute the instructions, processor 602 may retrieve the instructions from the internal register or internal cache and decode them. During or after execution of the instructions, processor 602 may write one or more results (which may be intermediate or final results) to the internal register or internal cache. Processor 602 may then write one or more of those results to memory 604. In particular embodiments, processor 602 executes only instructions in one or more internal registers or internal caches or in memory 604 (as opposed to storage 606 or elsewhere) and operates only on data in one or more internal registers or internal caches or in memory 604 (as opposed to storage 606 or elsewhere). One or more memory buses (which may each include an address bus and a data bus) may couple processor 602 to memory 604. Bus 612 may include one or more memory buses, as described below. In particular embodiments, one or more memory management units (MMUs) reside between processor 602 and memory 604 and facilitate accesses to memory 604 requested by processor 602. In particular embodiments, memory 604 includes random access memory (RAM). This RAM may be volatile memory, where appropriate Where appropriate, this RAM may be dynamic RAM (DRAM) or static RAM (SRAM). Moreover, where appropriate, this RAM may be single-ported or multi-ported RAM. This disclosure contemplates any suitable RAM. Memory 604 may include one or more memories 604, where appropriate. Although this disclosure describes and illustrates particular memory, this disclosure contemplates any suitable memory.

In particular embodiments, storage 606 includes mass storage for data or instructions. As an example and not by way of limitation, storage 606 may include a hard disk drive (HDD), a floppy disk drive, flash memory, an optical disc, a magneto-optical disc, magnetic tape, or a Universal Serial Bus (USB) drive or a combination of two or more of these. Storage 606 may include removable or non-removable (or fixed) media, where appropriate. Storage 606 may be internal or external to computer system 600, where appropriate. In particular embodiments, storage 606 is non-volatile, solid-state memory. In particular embodiments, storage 606 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 606 taking any suitable physical form. Storage 606 may include one or more storage control units facilitating communication between processor 602 and storage 606, where appropriate. Where appropriate, storage 606 may include one or more storages 606. Although this disclosure describes and illustrates particular storage, this disclosure contemplates any suitable storage.

In particular embodiments, I/O interface 608 includes hardware, software, or both, providing one or more interfaces for communication between computer system 600 and one or more I/O devices. Computer system 600 may include one or more of these I/O devices, where appropriate. One or more of these I/O devices may enable communication between a person and computer system 600. As an example and not by way of limitation, an I/O device may include a keyboard, keypad, microphone, monitor, mouse, printer, scanner, speaker, still camera, stylus, tablet, touch screen, trackball, video camera, another suitable I/O device or a combination of two or more of these. An I/O device may include one or more sensors. This disclosure contemplates any suitable I/O devices and any suitable I/O interfaces 608 for them. Where appropriate, I/O interface 608 may include one or more device or software drivers enabling processor 602 to drive one or more of these I/O devices. I/O interface 608 may include one or more I/O interfaces 608, where appropriate. Although this disclosure describes and illustrates a particular I/O interface, this disclosure contemplates any suitable I/O interface.

In particular embodiments, communication interface 610 includes hardware, software, or both providing one or more interfaces for communication (such as, for example, packet-based communication) between computer system 600 and one or more other computer systems 600 or one or more networks. As an example and not by way of limitation, communication interface 610 may include a network interface controller (NIC) or network adapter for communicating with an Ethernet or other wire-based network or a wireless NIC (WNIC) or wireless adapter for communicating with a wireless network, such as a WI-FI network. This disclosure contemplates any suitable network and any suitable communication interface 610 for it. As an example and not by way of limitation, computer system 600 may communicate with an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 600 may communicate with a wireless PAN (WPAN) (such as, for example, a BLUETOOTH WPAN), a WI-FI network, a WI-MAX network, a cellular telephone network (such as, for example, a Global System for Mobile Communications (GSM) network), or other suitable wireless network or a combination of two or more of these. Computer system 600 may include any suitable communication interface 610 for any of these networks, where appropriate. Communication interface 610 may include one or more communication interfaces 610, where appropriate. Although this disclosure describes and illustrates a particular communication interface, this disclosure contemplates any suitable communication interface.

In particular embodiments, bus 612 includes hardware, software, or both coupling components of computer system 600 to each other. As an example and not by way of limitation, bus 612 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local (VLB) bus, or another suitable bus or a combination of two or more of these. Bus 612 may include one or more buses 612, where appropriate. Although this disclosure describes and illustrates a particular bus, this disclosure contemplates any suitable bus or interconnect.

Herein, a computer-readable non-transitory storage medium or media may include one or more semiconductor-based or other integrated circuits (ICs) (such, as for example, field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, any reference herein to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

What is claimed is:

1. A method comprising:
receiving a request corresponding to a user interaction on a content platform with a content item, the user interaction originating from a user device;
determining, based on the request, an inventory item and a merchant provider of the inventory item;
confirming availability of the inventory item from the merchant provider;
receiving a checkout request for the inventory item via a native checkout user interface presented on the user device in conjunction with the content platform, the native checkout user interface corresponding to the inventory item determined from the request, the checkout request originating from the user device; and
facilitating an order between a user associated with the user device and the merchant provider based on the checkout request.

2. The method of claim 1, wherein the presentation of the native checkout user interface is determined by the content platform and integrates with the presentation of the content platform.

3. The method of claim 1, wherein the native checkout user interface is presented without the user device navigating away from the content platform.

4. The method of claim 1, further comprising:
retrieving a presentation template for the native checkout user interface, wherein the presentation template is determined by the merchant provider of the inventory item.

5. The method of claim 1, further comprising:
receiving order transaction information from the native checkout user interface;
receiving payment information for the user originating from the native checkout user interface; and
wherein an amount of funds corresponding to the order are transferred from an account of the user to an account of the merchant provider by a payment processor using the received payment information.

6. The method of claim 1, further comprising:
receiving identifying information for the user originating from the native checkout user interface;
identifying payment information for the user based on the identifying information by retrieving the payment information from a database mapping the identifying information of the user to the payment information; and
wherein an amount of funds corresponding to the order are transferred from an account of the user to an account of the merchant provider by a payment processor using the retrieved payment information.

7. The method of claim 1, wherein the merchant provider operates a merchant inventory system, the merchant inventory system being one of a plurality of merchant inventory systems, and wherein the method further comprises
identifying the merchant inventory system for the merchant provider from the plurality of merchant inventory systems;
wherein the content provided in the native checkout user interface is based on the identification of the merchant inventory system.

8. The method of claim 7, further comprising:
after receiving the checkout request for the inventory item via the native checkout user interface presented on the user device, sending an order notification to the merchant inventory system, wherein the content of the order notification is based on the identification of the merchant inventory system.

9. The method of claim 7, wherein confirming availability of the inventory item from the merchant provider comprises requesting an inventory updated from the merchant inventory system.

10. The method of claim 1, further comprising:
prior to receiving the checkout request for the inventory item via the native checkout user interface:
receiving a second request corresponding to a second user interaction on the content platform with a second content item, the user interaction originating from a user device;
determining, based on the second request, a second inventory item and a second merchant provider of the second inventory item; and
updating the native checkout user interface to correspond to the inventory item determined from the request and the second inventory item determined from the second request;
wherein receiving the checkout request for the inventory item via the native checkout user interface comprises associating the checkout request with the inventory item and the second inventory item; and
responsive to receiving the checkout request, facilitating a second order between the user and the second merchant provider.

11. The method of claim 1, wherein the content platform is a non-marketplace content platform.

12. The method of claim 1, wherein the request is received from an advertisement presented by the content platform.

13. A method comprising, by a user device of a user of a content platform:
displaying a user interface comprising a plurality of content items provided by the content platform;
receiving, via the user interface, an input corresponding to a first content item of the plurality of content items;
sending a request for additional content corresponding to the first content item;
displaying a native checkout user interface corresponding to a transaction processing system comprising an inventory item corresponding to the first content item determined from the request;
receiving, via the native checkout user interface, a second user input corresponding to an order request for the inventory item;
sending the order request to the transaction processing system; and
displaying the user interface comprising a second plurality of content items provided by the content platform.

14. The method of claim 13, wherein the native checkout user interface is displayed as an overlay over the user interface comprising the plurality of content items.

15. The method of claim 13, wherein the user device sends the request for additional content corresponding to the first content item to the content platform.

16. The method of claim 13, wherein the user device sends the request for additional content corresponding to the first content item to the transaction processing system.

17. The method of claim 13, wherein receiving the second user input corresponding to the order request for the inventory item comprises:
receiving a confirmation that payment information received from the transaction processing system and displayed within the native checkout user interface is correct; or
receiving input of payment information into a plurality of user input fields; and
receiving a confirmation that the payment information input into the user input fields is correct.

18. The method of claim 13, wherein the user interface comprising the plurality of content items is a user interface of an application associated with the content platform executing on the user device.

19. The method of claim 13, wherein the user interface comprising the plurality of content items is a user interface of a website associated with the content platform displayed within a web browser executing on the user device.

20. A system comprising:
a user device;
a transaction processing system; and
a merchant system;
wherein the user device is configured to:
display a plurality of content items provided by a content platform in an application executing on the user device;
receive a user input corresponding to a first content item of the plurality of content items; and
send a request to the transaction processing system based on the received user input;
wherein the transaction processing system is configured to:
identify an inventory item based on the request; and
send a request to the merchant system to confirm availability of the inventory item; wherein the user device is further configured to:
display a native checkout user interface for the inventory item without navigating away from the application executing on the user device;
receive an order request for the inventory item via the native checkout user interface; and
send the order request to the transaction processing system; and
wherein the transaction processing system is further configured to:
place an order for the inventory item with the merchant system based on receiving the order request.
